(19) United States
(12) Patent Application Publication
(10) Pub. No.: US 2024/0338499 A1
(43) Pub. Date: Oct. 10, 2024

(54) REAL-TIME ELECTRONIC CUSTOM ITEM DESIGN INTERFACE FOR MANUFACTURING

(71) Applicant: Stacklab, Toronto (CA)

(72) Inventors: Jeffrey Forrest, Toronto (CA); Devansh Shah, Toronto (CA); William Harford, Toronto (CA); James Munroe, Toronto (CA)

(73) Assignee: Stacklab, Toronto, ON (CA)

(21) Appl. No.: 18/293,421

(22) PCT Filed: Aug. 3, 2022
(86) PCT No.: PCT/CA2022/051180

§ 371 Date: Jan. 30, 2024

Related U.S. Application Data
(60) Provisional application No. 63/228,901, filed on Aug. 3, 2021.

(51) Int. Cl. G06F 30/17

(52) U.S. Cl. CPC G06F 30/17

(57) ABSTRACT

A system, method, and computer program product that includes a processor(s) standardizing data from sources that includes details for materials for integration into a custom-designed item. The processor(s) store the standardized data in a consolidated data set one or more databases accessible to an API. The processor(s) trigger the API, based on a selected in a graphical user interface communicatively coupled to the API, to query the one or more databases to obtain select data from the consolidated data set about a portion of the materials that could potentially fulfill a parameter for the custom-designed item. The processor(s) optimize the select data, to determine one or more physical layouts for the portion of the materials in the custom-designed item. The processor(s) render and display a two-dimensional model of the custom-designed object with the one or more physical layouts implemented into the custom-designed object.

### CROSS-REFERENCE TO RELATED APPLICATION

This PCT International Patent application claims priority to U.S. Provisional Patent Application No. 63/228,901, filed Aug. 3, 2021, and entitled REAL-TIME ELECTRONIC CUSTOM ITEM DESIGN INTERFACE FOR MANUFACTURING, the entire contents of which are hereby incorporated herein by reference.

### BACKGROUND OF INVENTION

Manufacturing of items, including household items, and, in particular, custom design of these items, is both heavily manual and inefficient in terms of waste production. For example, many manufacturing processes often produce waste product that is rarely recycled, or re-purposed, if at all. Making available to consumers increased customization options in manufactured items, which is desirable in the luxury goods market, can increase the amount of waste. Generally, procedures around the design and manufacturing of custom goods are regarded as standing in the way of optimization and efficiency, as these procedures place a disproportionate burden on infrastructural, human and environmental resources.

### SUMMARY OF INVENTION

Shortcomings of the prior art are overcome and additional advantages are provided through the provision of a system for automated generation of custom items. The system includes: a memory; one or more processors in communication with the memory; program instructions executable by the one or more processors via the memory to perform a method, the method. The method may include: standardizing, by the one or more processors, data from two or more sources, wherein the data comprises descriptive details for materials for integration into a custom-designed item; storing, by the one or more processors, the standardized data in a consolidated data set in one or more databases accessible to an application programming interface; triggering, by the one or more processors, the application programming interface, based on a selected in a graphical user interface communicatively coupled to the application programming interface, to query the one or more databases to obtain select data from the consolidated data set, wherein the select data comprises descriptions of a portion of the materials, wherein the portion of the materials potentially fulfill a parameter for the custom-designed item, wherein the parameter was configured by a user in the graphical user interface; optimizing, by the one or more processors, the select data, to determine one or more physical layouts for the portion of the materials in the custom-designed item; rendering, by the one or more processors, a two-dimensional model of the custom-designed object with the one or more physical layouts implemented into the custom-designed object; and displaying, by the one or more processors, the two-dimensional model, in the graphical user interface.

Shortcomings of the prior art are also overcome and additional advantages are provided through the provision of a method for automated generation of custom items. The method includes: standardizing, by one or more processors, data from two or more sources, wherein the data comprises descriptive details for materials for integration into a custom-designed item; storing, by the one or more processors, the standardized data in a consolidated data set in one or more databases accessible to an application programming interface; triggering, by the one or more processors, the application programming interface, based on a selected in a graphical user interface communicatively coupled to the application programming interface, to query the one or more databases to obtain select data from the consolidated data set, wherein the select data comprises descriptions of a portion of the materials, wherein the portion of the materials potentially fulfill a parameter for the custom-designed item, wherein the parameter was configured by a user in the graphical user interface; optimizing, by the one or more processors, the select data, to determine one or more physical layouts for the portion of the materials in the custom-designed item; rendering, by the one or more processors, a two-dimensional model of the custom-designed object with the one or more physical layouts implemented into the custom-designed object; and displaying, by the one or more processors, the two-dimensional model, in the graphical user interface.

Shortcomings of the prior art are also overcome and additional advantages are provided through the provision of a computer program product for automated generation of custom items. The computer program product includes a computer readable storage medium readable by one or more processors and storing instructions for execution by the one or more processors for performing a method comprising: standardizing, by the one or more processors, data from two or more sources, wherein the data comprises descriptive details for materials for integration into a custom-designed item; storing, by the one or more processors, the standardized data in a consolidated data set in one or more databases accessible to an application programming interface; triggering, by the one or more processors, the application programming interface, based on a selected in a graphical user interface communicatively coupled to the application programming interface, to query the one or more databases to obtain select data from the consolidated data set, wherein the select data comprises descriptions of a portion of the materials, wherein the portion of the materials potentially fulfill a parameter for the custom-designed item, wherein the parameter was configured by a user in the graphical user interface; optimizing, by the one or more processors, the select data, to determine one or more physical layouts for the portion of the materials in the custom-designed item; rendering, by the one or more processors, a two-dimensional model of the custom-designed object with the one or more physical layouts implemented into the custom-designed object; and displaying, by the one or more processors, the two-dimensional model, in the graphical user interface.

Systems, computer program products, and methods relating to one or more aspects of the technique are also described and may be claimed herein. Further, services relating to one or more aspects of the technique are also described and may be claimed herein.

Additional features are realized through the techniques of the present invention. Other embodiments and aspects of the invention are described in detail herein and are considered a part of the claimed invention.

### BRIEF DESCRIPTION OF DRAWINGS

One or more aspects of the present invention are particularly pointed out and distinctly claimed as examples in the claims at the conclusion of the specification. The foregoing and objects, features, and advantages of one or more aspects of the invention are apparent from the following detailed description taken in conjunction with the accompanying drawing.

FIG. 1 depicts a technical architecture into which aspects of some embodiments of the present invention are implemented.

FIG. 2 depicts a workflow illustrating certain aspects of some embodiments of the present invention.

FIG. 3 is an example of an item that can be designed utilizing various aspects of some embodiments of the present invention.

FIGS. 4A-4E depicts all or portions of screens in a graphical user interface (GUI) generated by program code in embodiments of the present invention.

FIG. 5 depicts a visual of a completed design for a given item generated utilizing aspects of some embodiments of the present invention.

FIG. 6 depicts a computer system configured to perform an aspect of an embodiment of the present invention.

FIG. 7 depicts a computer program product incorporating one or more aspects of the present invention.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. The terms software and program code are used interchangeably throughout this application and can refer to logic executed by both hardware and software. Components of the system that can be utilized to execute aspects of embodiments of the present invention may include specialized hardware, including but not limited to, a GPP, an FPGA and a GPU (graphics professor unit). Additionally, items denoted as processors may include hardware and/or software processors or other processing means, including but not limited to a software defined radio and/or custom hardware.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are communicatively connected, electrically connected, electrically coupled, optically connected, optically coupled, fluidly connected or fluidly coupled may or may not be in direct physical contact, and one or more other components may be positioned therebetween.

The terms “including” and “comprising”, as used herein, mean the same thing.

The terms “substantially”, “approximately”, “about”, “relatively”, or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to #10%, such as less than or equal to +5%, such as less than or equal to +2%, such as less than or equal to #1%, such as less than or equal to +0.5%, such as less than or equal to +0.2%, such as less than or equal to +0.1%, such as less than or equal to +0.05%. If used herein, the terms “substantially”, “approximately”, “about”, “relatively,” or other such similar terms may also refer to no fluctuations, that is, +0%.

Embodiments of the present invention include a method, system, and computer program product which provide real-time configuration and enable manufacturing of custom items where materials can be locally sourced and waste is reduces. As will be explained below, embodiments of the present invention provide to users of a custom interface, generated in examples herein, a participatory, accessible experience that leverages local manufacturing and disrupts waste cycles. Aspects of the present invention include innovative client and manufacturer facing tools to produce original, custom furnishings. In embodiments of the present invention, users at all stage of the item-creation process, including but not limited to, consumers, suppliers, manufacturers are provided with a graphical user interface that enables limitless customizations of objects (e.g., custom furnishings). This interactive digital interface enables real time design and transparent pricing. The interface is communicatively coupled to a database that stores data characterizing stored waste material inventories of partnering manufacturers. This inventory information is obtained and processed (filtered, formatted, standardized, etc.), in real-time, by program code executing on one of more processors, to enable options that include these materials to be accessible to the user, via the interface. In embodiments of the present invention, the program code executing on one or more processors also includes an optimization algorithm, which obtains selections by the user, in the interface, and locates, in the inventory, materials that can meet the parameters selected by the user, providing an optimized selection from the options available. Objects designed in the interface can be ordered for fabrication through an electronic commerce portal in embodiments of the present invention. The program code generates documentation sufficient for use in manufacturing and automatically provides the documentation to a resource capable of manufacturing the custom-generated object. Thus, embodiments of the present invention include program code that comprises tools for production, documentation, logistics, and coordination in the manufacturing of a custom item, configured utilizing the interface and purchased via the e-commerce portal.

Embodiments of the present invention are inextricably tied to at least computing because the connectivity and real-time selecting and automated processing in embodiments of the present invention are enabled by computing technology and were not previously possible without these aspects. For example, embodiments of the present invention enable the coordination and automation of a manufacturing process for a custom item, a non-limiting example used herein is a custom furnishing, that utilizes source materials (e.g., fabrics) which are considered waste, but for the processes herein making these materials accessible. For example, in embodiments of the present invention, secure network connectivity and data filtering and standardization algorithms enable program code to identify and retain waste products (e.g., remnants) as inventory in a custom database format such that the while a user designs and customizes an item via a custom interface, the program code of the aforementioned optimization algorithm, can identify materials in the custom database for fulfillment of the order. The computing system enables the connectivity and coordination of vendors (e.g., remnant vendors), customers, and fulfillment agents. Additionally, the system and method herein are practical because of their speed and transparency, which are enabled by the technical infrastructure. An individual can make selections and adjustments to design an item in an interface which behind the scenes, the program code sources the selections and provides immediate updates to the item design and the pricing, to the user, in the interface. This process is made practical/possible because of its technical infrastructure.

Embodiments of the present invention are directed to a practical application of enabling, in real-time, custom item generation coupled with reduction of manufacturing waste. Program code in embodiments of the present invention produces configurable instructions for manufacturing a custom-designed item. In some embodiments of the present invention, portions of the item can be fabricated by computerized means, including but not limited to, automated machines and/or three-dimensional printers. In these examples, upon generating the instructions, the program code can communicate with an apparatus to execute at least a portion of these instructions, resulting in at least a portion of the item being automatically fabricated. To afford these practical advantages, various computing advantages are provided by examples described herein, which represent significant improvements over highly manual and wasteful current practices. For example, data from multiple sources is standardized and stored in a database that can be accessed to provide options to a user utilizing an interface. The options provided are optimized by program code of an optimization algorithm, to reduce waste and to comport with the specifications the user provides, via the interface. Additionally, the resultant instructions are automatically distributed to entities (systems and organizations) for fulfillment of the orders. Technical improvements that enable the system and method include: 1) custom data processing procedures to standardize and store data from disparate sources in a centralized database; 2) an application programming interface (API) to provide queries formulated based on entries in a graphical user interface (GUI), to database objects and return results to the GUI; 3) the GUI to enable custom configuration of an item-actions in the GUI, by the user, are handled, on the backend, by the API; and 4) certain automated fabrication facilities to generate at least part of the item, based on the order generated through the user selecting options in the GUI.

Embodiments of the present invention represent significant improvements over current custom design and manufacturing methods for various items. A non-limiting example of an application of various aspects of the invention described herein is the custom furnishings industry. Aspects of the examples described herein include an innovative system that reimagines the creation and accessibility of designer collections. Through proprietary inventory management, algorithms and a digital consumer interface, the program code enables a user to transform effectively surplus cut-off and end-of-bolt felted wool, in one example, into an infinite range of seating experiences. The aspects described herein not only include program code that enables users to create original, configurable works, but also break waste cycles in custom design. Using a database of (e.g., felt remnants), supplied by third parties, including but not limited to regional manufacturers, textile waste is rescued (e.g., approximately 15,000 square feet of textile waste). In some embodiments, the material (felt) designed, configured by a user through an interface, will be supported with purpose-engineered structural systems that will recycle post-consumer (scrap) aluminum (e.g., approximately 35,000 cubic inches of post-consumer (scrap) aluminum). Materials utilized via the computing systems, computer program product, and method described herein to generate custom objects can include, but are not limited to felted wool, post consumer (e.g., old scrap) aluminum, and powder coating. In some examples, the program code can provide instructions to a specialized fabricator (e.g., a three-dimensional printer), to fabricate certain aspects of the custom-designed item.

Another non-limiting examples that evidences the significant improvements provided by aspects of embodiments of the present invention over existing over current custom design and manufacturing methods for various items is in the field of modular architecture Through proprietary inventory management, algorithms and a digital consumer interface, the program code enables a user to transform effectively building materials, including but not limited to, building materials, into modular architectural structures. Aspects of embodiments of the present invention enable the location and assembly, in unique combinations, of various materials, including would-be waste or excess building materials, into modular structures, including but not limited to, buildings. Using a database and a flexible data import and standardization interface, program code in embodiments of the present invention can present unique configurations of items to a user, and can generate and customize based on the selections of the user through a custom interface, generated by the program code.

Aspects of embodiments of the present invention represent significant improvements in design and manufacturing of custom goods. Custom goods traditionally stand in the way of optimization and efficiency, placing a disproportionate burden on infrastructural, human and environmental resources Aspects of the present invention embody a collaborative space for designers, manufacturers and consumers. Currently, in the custom goods industry, designers produce limited editions, and must often pass high production costs on to collectors. As will be discussed herein, some embodiments of the present invention include an interface and supporting backend architectures that automate design and manufacture of custom goods with a focus on using materials destined to become industrial waste. Customers can receive real time pricing feedback as they adjust their pieces in the interface. Aspects of the present invention represent a change to the custom goods industry, for example, by eliminating reliance on permanent tooling, such as dies and molds, which limit the ability of manufacturers to produce configurable products. Instead, embodiments of the present invention enable the creation of highly customizable goods with unlimited configurable options, which controlling both costs and environmental impact.

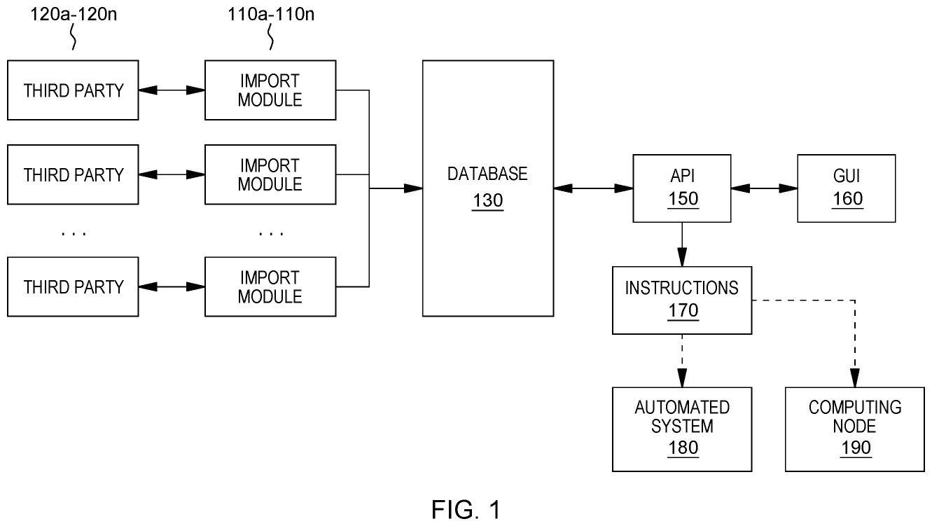

FIG. 1 depicts a technical architecture 100 that demonstrates the interconnectivity of different parts of this system for generating, in real-time, a detailed plan for manufacturing an item, utilizing materials which were formerly waste. As aforementioned, an advantage of embodiments of the present invention, is that the program code sources the materials to be utilized in fabricating/manufacturing the item, based on the program code receiving inventory (e.g., remnants), from various sources. Thus, an item plan generated by the program code will include the materials to be utilized in completion of the item. For ease of understanding, certain functionalities of the program code (executing on one or more processors 140) are broken into different modules. This modular architecture is provided as a non-limiting example for illustrative purposes only as one of skill in the art would recognize that various functionalities can be combined and/or separated into different modules in many different combinations.

Turning to FIG. 1, the technical architecture includes program code comprising import modules 110a-110n, which connect with various third-party systems 120a-120n to ingest material (e.g., remnant) information. The import modules 110a-110n each include customized program code to obtain data from a given third-party and to standardize the data into a format that can be saved one or more centralized databases 130. The database stores data related to the remnants, including but not limited to, parameters, and also, in some embodiments of the present invention, images of the materials. Program code of the import modules 110a-110n can be configured to continuously obtain and format data from the third-party systems 120a-120n and/or the imports can be scheduled. In some embodiments, the program code can include a frontend and/or backend trigger to initiate the import modules 110a-110n.

As illustrated in FIG. 1, the one or more centralized databases 130 (in which the now-standardized third-party data is stored), are accessed by program code comprising an API 150. The API 150 provides an interface between a GUI 160 and the data in the one or more centralized databases 130. The program code generates the GUI 160 (which can utilize a third-party browser), in which a user can configure an item. The manner in which a user connects to the GUI can vary as a user can utilize any computing node, including but not limited to, a laptop, touchpad computer, and/or a smartphone.

As the user makes selections, the API 150, behind the scenes, gathers and optimizes (utilizing an optimization algorithm) materials for fulfillment of the selections by the user. In some embodiments of the present invention, as the user works through the GUI 160 and makes various choices, the materials which can be utilized in the item being designed by the user will change. Thus, the API 150, in real-time, can query the data set in the one or more databases 130 to update selections displayed to the user by the program code. The API 150, utilizing the optimization algorithm, can determine which materials can potentially fit a selection by the user in the GUI 160 and whether the materials can be combined in the manner specified to create the item.

Various features of the GUI 160 will be discussed in greater detail herein. However, based, in some examples, on entries by a user in the GUI 160, utilizing the algorithm, the program code finds materials most suited to create the item the user of the GUI 160 is customizing in this GUI 160. Based on this type of determinations, the program code displays the available options to the user, via the GUI 160. The program code provides real time pricing feedback as the user adjusts the item in the GUI 160. The interactions between the GUI 160, the API 150, and the one or more databases 130, enable the user to customize an item in in real-time, meaning that information relevant to the item is constantly updated in the GUI. When the item has been completely designed and finalized by the user, via the GUI 160, the program code, in some embodiments of the present invention, generates instructions 170 for fabrication/manufacture of the item. This program code module can be understood to be an automated production, documentation, logistics, and coordination tool. In some embodiments of the present invention, the program code provides certain of the instructions to an automated manufacturing apparatus 180, including but not limited to a three-dimensional printer, and the manufacturing apparatus fabricates the item in accordance with the instructions. In some embodiments of the present invention, a portion of the item is generated automatically.

In some embodiments of the present invention, the program code generates instructions for fabricating/manufacturing the custom item and sends notifications to the third-party sources of selected materials. In some examples, the instructions specify the materials and request that the supplier send the selected materials to a given manufacturing or fabrication facility. The program code sends a computing node 190 at the given manufacturing or fabrication facility the instructions. Thus, when the given manufacturing or fabrication facility has received the materials, it can utilize the instructions to create the designed item. The materials and the instructions can be marked with a unique identifier generated by the program code to streamline the process.

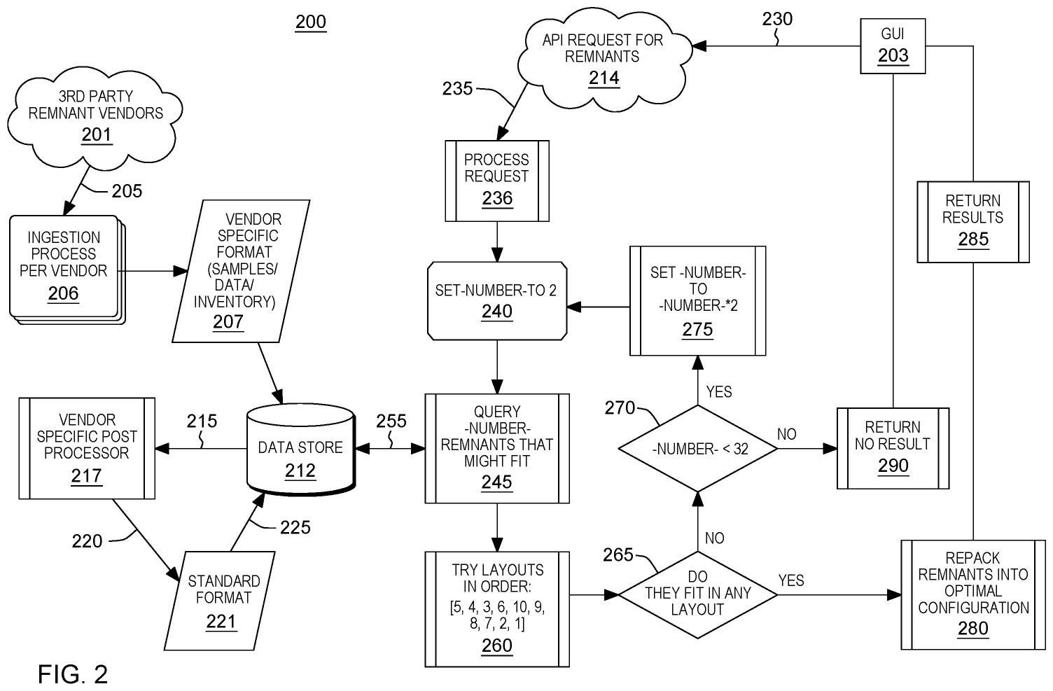

FIG. 2 is a workflow 200 that includes certain aspects of a technical environment into which one or more aspects of the present invention can be implemented. This workflow can be viewed as processes initiated by program code executing on one or more processors from a point-of-view of a third-party vendor 201, and processes initiated and interacting with the aforementioned API 214. As discussed in FIG. 1, the API 214 serves as an interface between a GUI 203 and one or more databases, referred to in the example of FIG. 2 as a data store 212.

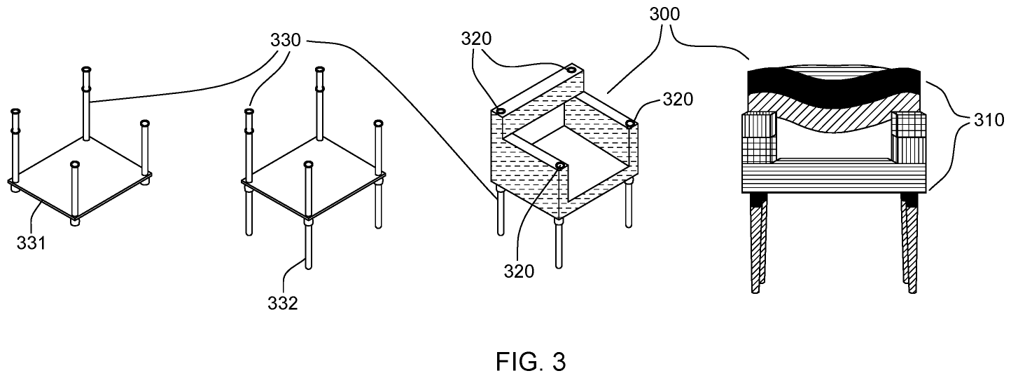

Turning to the GUI 203, via the GUI 203, which can be characterized as an online configurator, users can build, configure and preview items, they design. A non-limiting example used herein to understand this functionality is utilizing the GUI 203 to design custom furniture. Parameters related to the item to be designed using the GUI 203 are preconfigured, including a set of fixed proportions/functional programs for a given item. Thus, the GUI 203 enables the user to customize a given item based on established dimensional principles tied to material use. In a non-limiting example, items customized by a user, via the GUI 203 include customizable furniture pieces based on a large variety of optimized frameworks, ranging between stools, benches, chairs and/or day beds, based on or efficient fractions ofindustrial material dimensions. FIG. 3 is an example of a chair 300 that can be designed utilizing the GUI 203. The chair 300 is comprised of layers of remnants 310, secured by hardware 320. The thickness of the chair 300 is defined by the minimum or incremental quantity of felt (remnants) available, while the overall height can be defined freely based on a frame (e.g., an aluminum frame 330). As illustrated in FIG. 2, in some examples, to minimize cutting waste, the layers that comprise the soft surfaces of the chair 300, are sourced from a data store 212 of available offcuts and end-of-bolt material. Various other design options can be provided to the user via the GUI 203, including but not limited to, a finish for the frame 330 of the item. In some embodiments of the present invention, the frame 330 is available (for selection) in any color, or treatment, including but not limited to, powder coating, paint, polished, sandblasted, and/or sanded. This frame 330 includes extrusions (e.g., aluminum extrusions) 332 for legs, and a base plate (e.g., aluminum sheet) 331, forming a base for the seat. The base 331 for the seat can be understood as a base plate for the item. As the sizing of the frame elements vary, the requirements for the materials (e.g., felt), will change, but the GUI 214 will reflect the impact of these changes in real-time, based on the behind-the-scenes work of the program code. In some embodiments of the present invention, the frame elements could be printed three dimensionally and the printing could be triggered automatically by the GUI 214, based on the completion of the design.

Returning to FIG. 2, starting at the left side of the workflow, program code comprising an ingestion program 206 (which can be customized for each vendor), ingests data regarding materials (e.g., remnants), from third party vendors 201 (205). In this example, the data, which in initially in a vendor-specific format 207, is stored, by the program code, in a data store 212 (210). The program code extracts the data from the database at regular or scheduled intervals and/or continuously (215), to process the data, utilizing vendor-specific post-processing 217, to convert the data to s standard format 221 (220). The program code saves the data, which is now in a standard format 221, in the data store 212 (225).

Moving to the right side of the workflow, the API 214 receives a request, based on an action in the GUI 203 (230). The request is received (235) by the optimization algorithm 236, which interacts with the database in order to respond to the request with a best fit of material(s) represented by the data in the data store 212. In the furniture example, the materials can include felt remnants, provided by the vendors in various thicknesses and colors. The optimization algorithms in the program code can enable the user to design an item that combines different materials under pre-defined circumstances, including but not limited to, if the combination is part of a minimum order to provide the optimal utility of the materials.

The program code sets a NUMBER value, in this examples, the value is “2”, but this is provided for illustrative purposes only. The program code queries the NUMBER of materials (remnants) that fit parameters of the request provided to the API by user selection through the GUI 203 (the GUI 203 was generated by the program code, in a client device) (245). Based on executing the query, in accordance with the NUMBER and the parameters, the program code obtains results from the data store 212 (255). The program code attempts to find acceptable and/or best fits by trying layouts of materials in order (260). The program code determines whether the materials (e.g., remnants) fit in any layout (or the configured layouts for the item being designed in the GUI 203 by the user) (265). Returning to the furniture example, because more than one material remnant can be combined to fulfill a request from the API 214 (via the GUI 203), a thickness of a felt (used here as an example of a material) associated with a request can be defined by the minimum or incremental quantity of felt available. Based on determining the materials fit in any layout, the program code repacks the materials (e.g., remnants) into an optimal configuration (280) and returns the results to the user, in the GUI 203 (285). In addition to returning the results to the user, or instead of returning the results to the user, in some embodiments of the present invention, if there is a single optimal layout and no further user selection is needed for a given item, the program code can provide the results directly, as an order, to a manufacturer. In cases where production is automated, the program code can provide instructions to the automated mechanisms for production of the item (e.g., a three-dimensional printer, an automated assembly line, etc.).

Below are various parameters which can be configured for a given item to be designed using the GUI 203. This example provides the type of parameters for a chair with 4″ leg (4 legs). The specific parameters are provided for the sole purpose of illustrating certain of the data utilized by the API 214 when querying the data store 212 to find an optimal solution for a give design request from the API 214, via the GUI 203.
Chair
Width=18″-40″
Depth=20″-40″
Seat height=16″-20″
Back height=12″-48″ (from top of seat to top of back)
Plate thickness=0.25″
Felt thickness=0.19685″ (TBC)
Min leg height=2″
Min number of seat layers=10
Leg inset=0.5″
Min gap between the legs=0.5″
Chamfer bottom edge of foot=0.13″
Plate fillet radius=Leg radius+leg inset=2.5″
Max span between legs=30″ (edge to edge)
Add option with no filleted corners

In the case where the materials do not fit the layout (265), the program code checks to determine whether the NUMBER variable (utilized to query the data store 212) is less than 32 (another example value provided for illustrative purposes, only) (270). If the NUMBER is not less than 32, the program code returns no result to the GUI 203 (290). The return of no results means that there are no materials (remnants) available to fulfill the request being made, via the API 214, based on the designs selected by the user in the GUI 203. The user can then change the selections in the GUI 203 to initiate a new request, which could have a result. If the NUMBER is less than 32, the program code resets the NUMBER value to a second option (the program code, via the algorithm, optimizes the selections to find a best fit for materials, thus, a next desired outcome can be a second choice) (275). The program code then proceeds to set the new value to 2 and repeat the query process (245). As aforementioned, the workflow 200 can results in the configuration of a complete set of options for a custom design, generated by a user, via the GUI 214. As the program code continuously pulls data from the third-party vendors 201, a given request can produce different results depending on the timing of the request. Thus, in some embodiments of the present invention, the program code can retain a request for which there is not result and execute it repeatedly within a given time window to eventually generate a plan for the design, based on newly acquired materials.

In some embodiments of the present invention, the result returned to the GUI 203 (285) include one or more of, specifications for the creation of a custom piece and an estimate for the custom piece. In some embodiments of the present invention, the program code automatically requests a quote from a manufacturer (with a computing node communicatively coupled to the one or more processors executing the program code). This program code can obtain the quote responsive to this request and the quote can include lead time, and a production tracker. The user can view the production tracker progress via the GUI 203. The program code can communicate the specifications for the item to relevant third parties, including but not limited to, handlers.

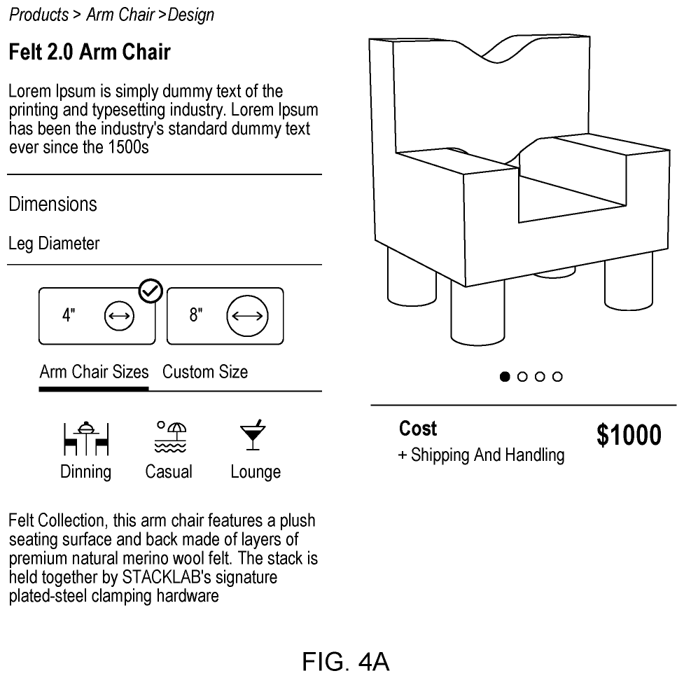

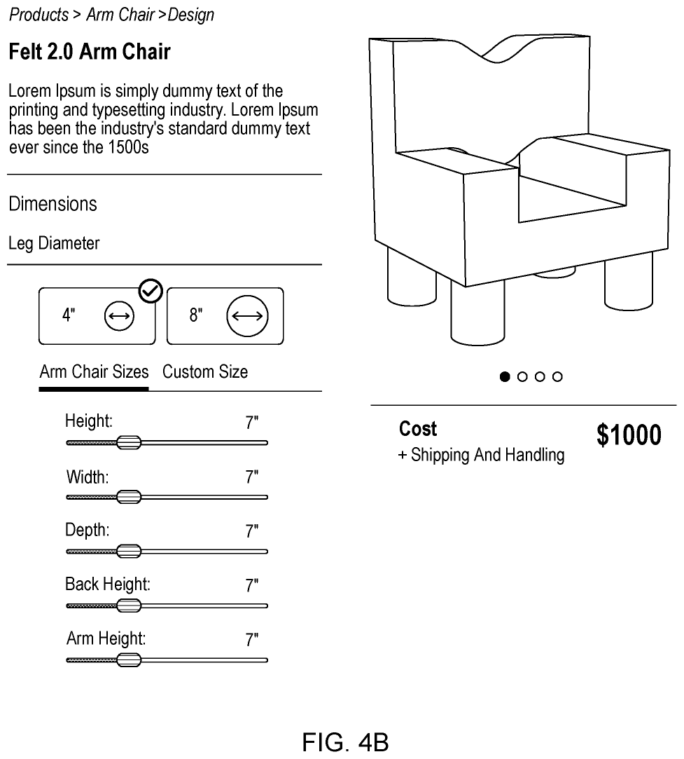

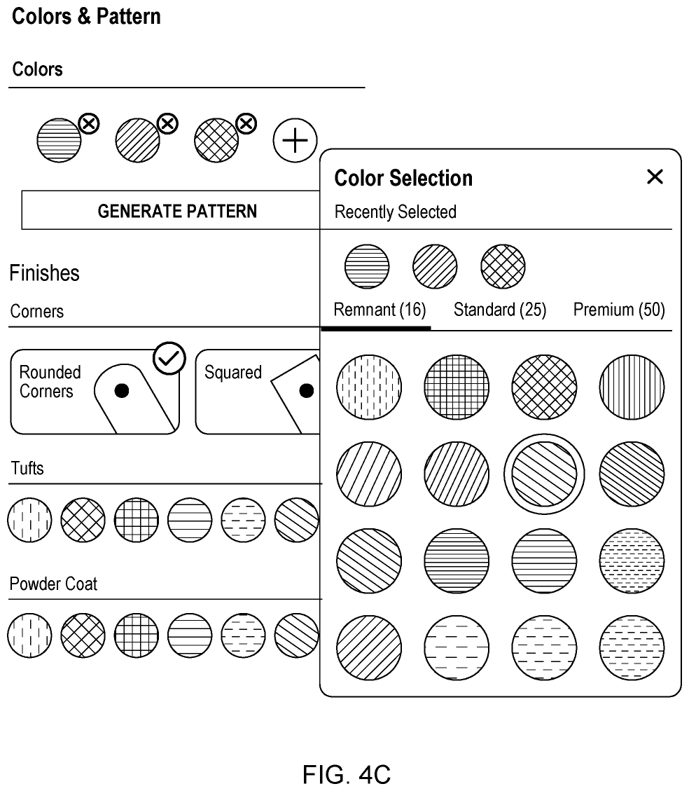

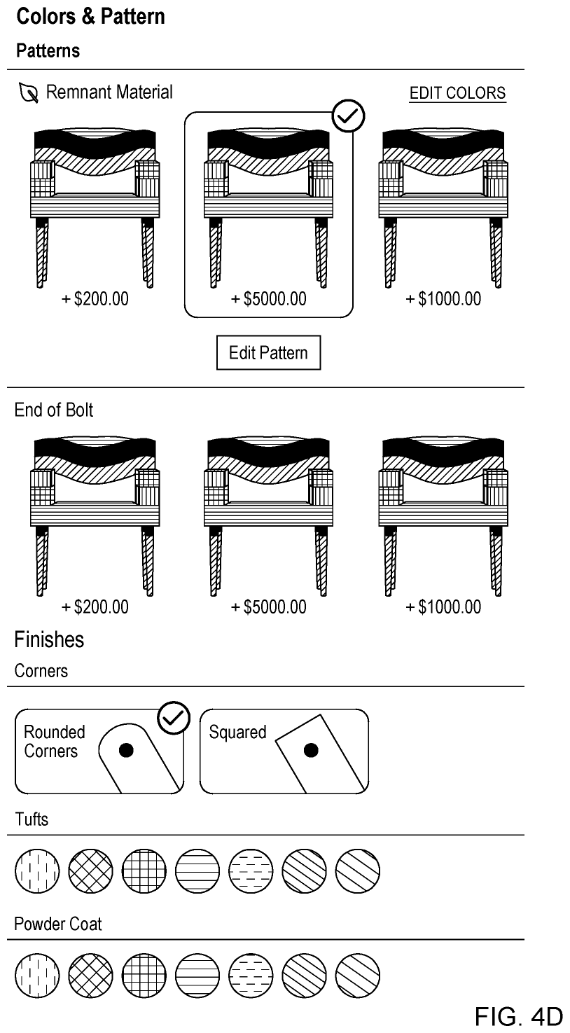

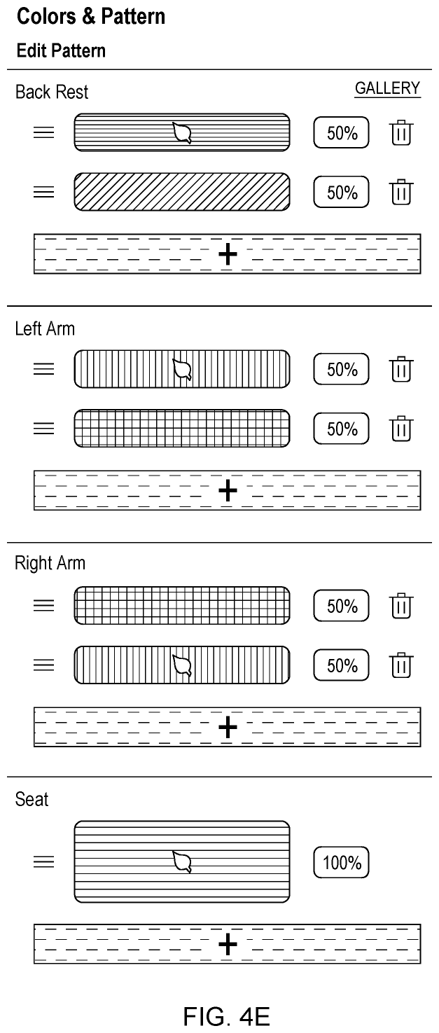

FIGS. 4A-4E return to an example of a chair and demonstrate various customizable features that a user can select in the GUI. As aforementioned, information related to materials as well as pricing is updated, via the API, in real-time. Certain dimensions of the item are pre-configured but the materials that complete the item and the characteristics of these materials (e.g., color) are selected by the user, via the GUI, based on the data being fetched and updated in real-time, by the program code. FIG. 4A is a rendering, as in the GUI, of the item, a chair, which the user will be customizing. The pricing information is displayed and is updated on the screen, in real-time, should materials selected by the user or characteristics of the materials impact the pricing. In FIG. 4A, an option is visible for a user to select a leg diameter.

In FIG. 4B, having selected the leg diameter, the user can select various dimensions. In this non-limiting example, the dimensions include height, width, depth, back height, and arm height. These aspects would vary based on the item being designed in the GUI.

FIG. 4C displays a screen of a GUI, or a portion of a screen, where a user is prompted to select colors and patterns. The options provided on the screens are populated by the API, based on applying an optimization algorithm and querying the data store, which includes all the information about the available materials. Options to select remnants, standard materials, and premium materials are all provided in this non-limiting example. The remnant information in obtained by the program code from the database.

FIG. 4D displays options in the GUI for patterns (ordering of the selected materials) and finishes (pre-configured). As the materials selected are stacked in this example, a user can utilize the GUI to reorder the stack to meet aesthetic or other preferences. Finishes available for election in this example include rounded or squared corners and tufts or a powder coat in various colors. FIG. 4D also depicts the real-time price adjustments that can be made in the interface as depending on the pattern selected, the price will change. FIG. 4D shows an option to edit colors, which is shown in more detail in FIG. 4E.

In FIG. 4E, the user has selected an option to edit a given pattern, which includes layers of various colors. The user can utilize the displayed interface controls to edit the various colored layers that comprise the pattern in various parts of the item, in this case, the chair (back, right arm, left arm, seat).

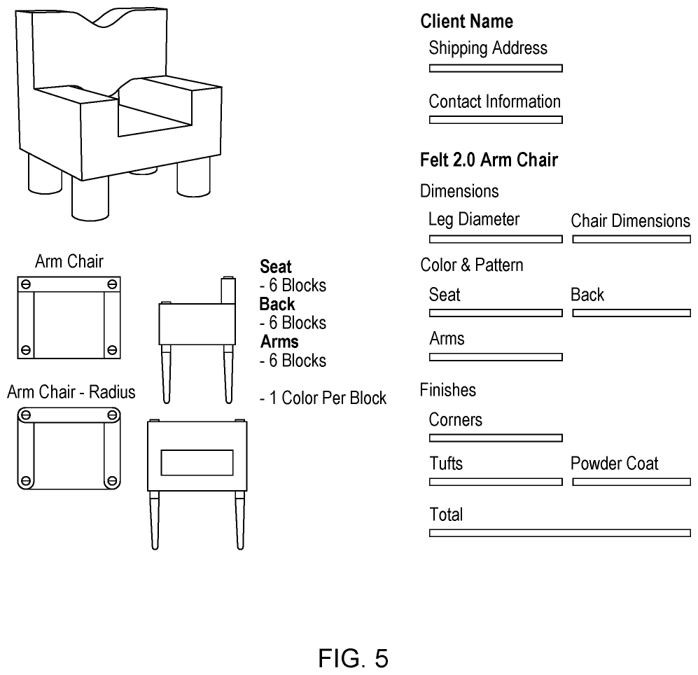

FIG. 5 is an example of a completed order generated by the program code. The completed order can be viewed and confirmed, via the GUI. However, the order can also be utilized to generate communications behind-the-scenes, including but not limited to requests for estimates, work orders, and commands to automated manufacturing machines.

Embodiments of the present invention include system, methods, and computer program products, for automatically generating a custom design for an item and optionally implementing the design in an automated manufacturing system. In some embodiments of the present invention, program code executing on one or more processors standardizes data from two or more sources, wherein the data comprises descriptive details for materials for integration into a custom-designed item. The program code stores the standardized data in a consolidated data set in one or more databases accessible to an application programming interface. The program code triggers the application programming interface, based on a selection in a graphical user interface communicatively coupled to the application programming interface, to query the one or more databases to obtain select data from the consolidated data set, wherein the select data comprises descriptions of a portion of the materials, wherein the portion of the materials potentially fulfill a parameter for the custom-designed item, wherein the parameter was configured by a user in the graphical user interface. (A portion of a material can fulfill a parameter when it meets various pre-defined specifications but has not yet been selected by a user for inclusion in the final design.) The program code optimizes the select data, to determine one or more physical layouts for the portion of the materials in the custom-designed item. The program code renders a two-dimensional model of the custom-designed object with the one or more physical layouts implemented into the custom-designed object. The program code displays the two-dimensional model, in the graphical user interface.

In some examples, standardizing data from two or more sources comprises: the program code continuously ingesting, separately from each source of the two or more sources, the data. The program code can also filter the data to obtains values representing parameters utilized in configuring the custom-designed object in the graphical user interface. The program code can also format the filtered data from each of the two or more sources in a pre-determined standard format.

In some examples, the program code obtains a selection of a layout of the one or more physical layouts displayed in the graphical user interface. The program code updates pricing information related to the custom-designed item, based on the selected layout.

In some examples, the program code obtains a selection of a layout of the one or more physical layouts displayed in the graphical user interface, wherein the selection comprises a change in the ordering of the portion of the materials in the custom-designed item. The program code updates the two-dimensional model of the custom-designed object to reflect the change. The program code displays the updated two-dimensional model, in the graphical user interface.

In some examples, the program code monitors selections made in the graphical user interface related to the custom-designed item. The program code continuously determines in real-time, whether any element related to the custom-designed item displayed in the graphical user interface is impacted by the selections. Based on the program code determining that a given element is impacted by a given selection of the selections, the program code adjusts, in real-time, visual elements on the graphical user interface related to the given element to reflect the impact.

In some examples, the given element is selected from the group consisting of: color, material, price, visual appearance, quality, and measurement.

In some examples, the program code obtains a selection of a layout of the one or more physical layouts displayed in the graphical user interface. The program code obtains an indicator from the graphical user interface that the custom-designed item is complete. The program code automatically initiates a predefined action based one the indicator.

In some examples, the predefined action comprises: the program code generating, by the one or more processors, a dynamic project plan for fabrication of the custom-designed item. The program code also continuously displays the dynamic project plan in the graphical user interface during fabrication of the custom-designed item to provide status to a user of the graphical user interface.

In some examples, the predefined action comprises: the program code transmitting, instructions to at least one automated manufacturing machine to fabricate at least one portion of the custom-designed item, wherein based on receiving the transmitted instructions, the automated manufacturing machine commenced fabricating the at least one portion.

In some examples, the predefined action comprises: the program code transmitting, to a predefined address, a request for an estimate for fabricating the custom-designed item.

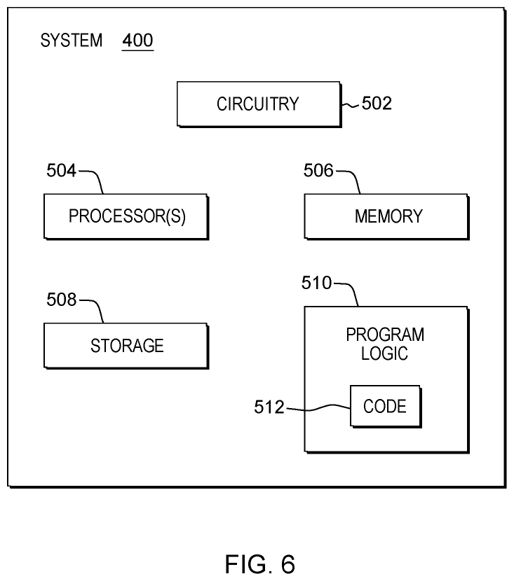

FIG. 6 illustrates a block diagram of a resource 400 in computer system, such as, which is part of the technical architecture of certain embodiments of the technique. For example, the resource can comprise the one or more processors upon which the program code executes, as well as resources of the data store. Returning to FIG. 6, the resource 400 may include a circuitry 502 that may in certain embodiments include a microprocessor 504. The computer system 400 may also include a memory 506 (e.g., a volatile memory device), and storage 508. The storage 508 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 508 may comprise an internal storage device, an attached storage device and/or a network accessible storage device. The system 400 may include a program logic 510 including code 512 that may be loaded into the memory 506 and executed by the microprocessor 504 or circuitry 502.

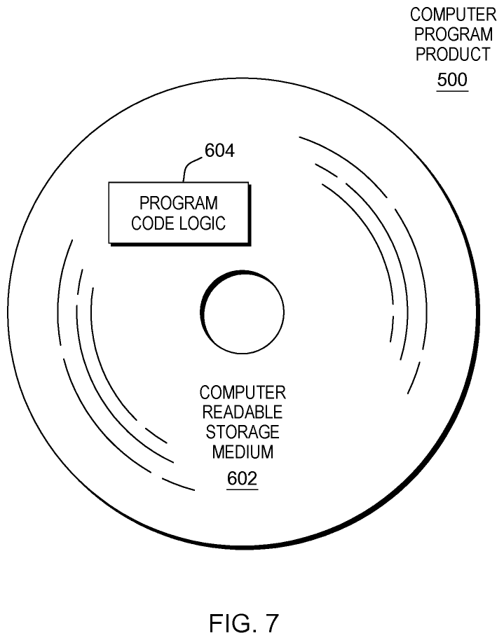

In certain embodiments, the program logic 510 including code 512 may be stored in the storage 508, or memory 506. In certain other embodiments, the program logic 510 may be implemented in the circuitry 502. Therefore, while FIG. 7 shows the program logic 510 separately from the other elements, the program logic 510 may be implemented in the memory 506 and/or the circuitry 502. The program logic 510 may include the program code discussed in this disclosure that facilitates the reconfiguration of elements of various computer networks, including those in various figures.

Using the processing resources of a resource 400 to execute software, computer-readable code or instructions, does not limit where this code can be stored. Referring to FIG. 7, in one example, a computer program product 500 includes, for instance, one or more non-transitory computer readable storage media 602 to store computer readable program code means or logic 604 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus, or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the technique may be written in any combination of one or more programming languages, including an object oriented programming language, such as Java, Smalltalk, C++ or the like, and conventional procedural programming languages, such as the “C” programming language, PHP, ASP, assembler or similar programming languages, as well as functional programming languages and languages for technical computing (e.g., Python, Matlab). The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Furthermore, more than one computer can be used for implementing the program code, including, but not limited to, one or more resources in a cloud computing environment.

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions, also referred to as software and/or program code, may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technique. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique.

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or steps plus function elements in the descriptions below, if any, are intended to include any structure, material, or act for performing the function in combination with other elements as specifically noted. The description of the technique has been presented for purposes of illustration but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular uses contemplated.

1. A computer-implemented method comprising:
standardizing, by one or more processors, data from two or more sources, wherein the data comprises descriptive details for materials for integration into a custom-designed item;
storing, by the one or more processors, the standardized data in a consolidated data set in one or more databases accessible to an application programming interface;
triggering, by the one or more processors, the application programming interface, based on a selection in a graphical user interface communicatively coupled to the application programming interface, to query the one or more databases to obtain select data from the consolidated data set, wherein the select data comprises descriptions of a portion of the materials, wherein the portion of the materials potentially fulfill a parameter for the custom-designed item, wherein the parameter was configured by a user in the graphical user interface;
optimizing, by the one or more processors, the select data, to determine one or more physical layouts for the portion of the materials in the custom-designed item;
rendering, by the one or more processors, a two-dimensional model of the custom-designed object with the one or more physical layouts implemented into the custom-designed object; and
displaying, by the one or more processors, the two-dimensional model, in the graphical user interface.

2. The computer-implemented method of claim 1, wherein standardizing data from two or more sources comprises:
continuously ingesting, by the one or more processors, separately from each source of the two or more sources, the data;
filtering, by the one or more processors, the data to obtains values representing parameters utilized in configuring the custom-designed object in the graphical user interface; and
formatting, by the one or more processors, the filtered data from each of the two or more sources in a pre-determined standard format.

3. The computer-implemented method of claim 1, further comprising:
obtaining, by the one or more processors, a selection of a layout of the one or more physical layouts displayed in the graphical user interface; and
updating, by the one or more processors, pricing information related to the custom-designed item, based on the selected layout.

4. The computer-implemented method of claim 1, further comprising:
obtaining, by the one or more processors, a selection of a layout of the one or more physical layouts displayed in the graphical user interface, wherein the selection comprises a change in the ordering of the portion of the materials in the custom-designed item;
updating, by the one or more processors, the two-dimensional model of the custom-designed object to reflect the change; and
displaying, by the one or more processors, the updated two-dimensional model, in the graphical user interface.

5. The computer-implemented method of claim 1, further comprising:
monitoring, by the one or more processors, selections made in the graphical user interface related to the custom-designed item;
continuously determining, by the one or more processors, in real-time, whether any element related to the custom-designed item displayed in the graphical user interface is impacted by the selections; and
based in determining, by the one or more processors, that a given element is impacted by a given selection of the selections, adjusting, in real-time, visual elements on the graphical user interface related to the given element to reflect the impact.

6. The computer-implemented method of claim 5, wherein the given element is selected from the group consisting of: color, material, price, visual appearance, quality, and measurement.

7. The computer-implemented method of claim 1, further comprising:
obtaining, by the one or more processors, a selection of a layout of the one or more physical layouts displayed in the graphical user interface;
obtaining, by the one or more processors, an indicator from the graphical user interface that the custom-designed item is complete; and
automatically initiating, by the one or more processors, a predefined action based one the indicator.

8. The computer-implemented method of claim 7, wherein the predefined action comprises:
generating, by the one or more processors, a dynamic project plan for fabrication of the custom-designed item; and
continuously displaying, by the one or more processors, the dynamic project plan in the graphical user interface during fabrication of the custom-designed item to provide status to a user of the graphical user interface.

9. The computer-implemented method of claim 7, wherein the predefined action comprises:
transmitting, by the one or more processors, instructions to at least one automated manufacturing machine to fabricate at least one portion of the custom-designed item, wherein based on receiving the transmitted instructions, the automated manufacturing machine commenced fabricating the at least one portion.

10. The computer-implemented method of claim 7, wherein the predefined action comprises:
transmitting, by the one or more processors, to a predefined address, a request for an estimate for fabricating the custom-designed item.

11. A computer program product comprising:
a computer readable storage medium readable by one or more processors and storing instructions for execution by the one or more processors for performing a method comprising:
standardizing, by the one or more processors, data from two or more sources, wherein the data comprises descriptive details for materials for integration into a custom-designed item;
storing, by the one or more processors, the standardized data in a consolidated data set in one or more databases accessible to an application programming interface;
triggering, by the one or more processors, the application programming interface, based on a selected in a graphical user interface communicatively coupled to the application programming interface, to query the one or more databases to obtain select data from the consolidated data set, wherein the select data comprises descriptions of a portion of the materials, wherein the portion of the materials potentially fulfill a parameter for the custom-designed item, wherein the parameter was configured by a user in the graphical user interface;
optimizing, by the one or more processors, the select data, to determine one or more physical layouts for the portion of the materials in the custom-designed item;
rendering, by the one or more processors, a two-dimensional model of the custom-designed object with the one or more physical layouts implemented into the custom-designed object; and
displaying, by the one or more processors, the two-dimensional model, in the graphical user interface.

12. The computer program product of claim 11, wherein standardizing data from two or more sources comprises:
continuously ingesting, by the one or more processors, separately from each source of the two or more sources, the data;
filtering, by the one or more processors, the data to obtains values representing parameters utilized in configuring the custom-designed object in the graphical user interface; and
formatting, by the one or more processors, the filtered data from each of the two or more sources in a pre-determined standard format.

13. The computer program product of claim 11, further comprising:
obtaining, by the one or more processors, a selection of a layout of the one or more physical layouts displayed in the graphical user interface; and
updating, by the one or more processors, pricing information related to the custom-designed item, based on the selected layout.

14. The computer program product of claim 11, further comprising:
obtaining, by the one or more processors, a selection of a layout of the one or more physical layouts displayed in the graphical user interface, wherein the selection comprises a change in the ordering of the portion of the materials in the custom-designed item;
updating, by the one or more processors, the two-dimensional model of the custom-designed object to reflect the change; and
displaying, by the one or more processors, the updated two-dimensional model, in the graphical user interface.

15. The computer program product of claim 11, further comprising:
monitoring, by the one or more processors, selections made in the graphical user interface related to the custom-designed item;
continuously determining, by the one or more processors, in real-time, whether any element related to the custom-designed item displayed in the graphical user interface is impacted by the selections; and
based in determining, by the one or more processors, that a given element is impacted by a given selection of the selections, adjusting, in real-time, visual elements on the graphical user interface related to the given element to reflect the impact.

16. The computer program product of claim 15, wherein the given element is selected from the group consisting of: color, material, price, visual appearance, quality, and measurement.

17. The computer program product of claim 11, further comprising:
obtaining, by the one or more processors, a selection of a layout of the one or more physical layouts displayed in the graphical user interface;
obtaining, by the one or more processors, an indicator from the graphical user interface that the custom-designed item is complete; and
automatically initiating, by the one or more processors, a predefined action based one the indicator.

18. The computer program product of claim 17, wherein the predefined action comprises:
generating, by the one or more processors, a dynamic project plan for fabrication of the custom-designed item; and
continuously displaying, by the one or more processors, the dynamic project plan in the graphical user interface during fabrication of the custom-designed item to provide status to a user of the graphical user interface.

19. The computer program product of claim 17, wherein the predefined action comprises:
transmitting, by the one or more processors, instructions to at least one automated manufacturing machine to fabricate at least one portion of the custom-designed item, wherein based on receiving the transmitted instructions, the automated manufacturing machine commenced fabricating the at least one portion.

20. A system comprising:
a memory;
one or more processors in communication with the memory;
program instructions executable by the one or more processors via the memory to perform a method, the method comprising:
standardizing, by the one or more processors, data from two or more sources, wherein the data comprises descriptive details for materials for integration into a custom-designed item;
storing, by the one or more processors, the standardized data in a consolidated data set in one or more databases accessible to an application programming interface;
triggering, by the one or more processors, the application programming interface, based on a selected in a graphical user interface communicatively coupled to the application programming interface, to query the one or more databases to obtain select data from the consolidated data set, wherein the select data comprises descriptions of a portion of the materials, wherein the portion of the materials potentially fulfill a parameter for the custom-designed item, wherein the parameter was configured by a user in the graphical user interface;
optimizing, by the one or more processors, the select data, to determine one or more physical layouts for the portion of the materials in the custom-designed item;
rendering, by the one or more processors, a two-dimensional model of the custom-designed object with the one or more physical layouts implemented into the custom-designed object; and
displaying, by the one or more processors, the two-dimensional model, in the graphical user interface.
